(19) United States
(12) Patent Application Publication
(10) Pub. No.: US 2016/0275093 A1
(43) Pub. Date: Sep. 22, 2016

(54) CREATING AND DEPLOYING DYNAMIC CONTENT EXPERIENCES

(71) Applicant: Zmags, Inc., Boston, MA (US)

(72) Inventors: Thomas Majoch, Charlestown, MA (US); Gorm Casper, Valby (DK); Soren Harder, Copenhagen (DK); Poul Henriksen, Copenhagen (DK); Kim Knudsen, Solrod Strand (DK); Antonio Lagrotteria, Copenhagen (DK); Yijie Li, Copenhagen (DK); Jacob Midtgaard-Olesen, Odense (DK); Anne Sophie Østergaard, Copenhagen (DK); Gunni Rode, Vanlose (DK); Jacob Sloth-Brodersen, Skovlunde (DK); Pedro Augusto Freitas de Souza, Gentofte (DK); Andreea Vasile, Copenhagen (DK); Christian Leifelt, Copenhagen (DK); Jonas Zimling, Copenhagen (DK); Mette Damsgaard, Copenhagen (DK); Sune Wettersteen, Copenhagen (DK); Jens Lauritsen, Copenhagen (DK); Younes Peters Touati, Copenhagen (DK); Laurent Mauvais, Copenhagen (DK)

(21) Appl. No.: 15/074,694

(22) Filed: Mar. 18, 2016

Related U.S. Application Data
(60) Provisional application No. 62/135,152, filed on Mar. 18, 2015.

(51) Int. Cl. G06F 17/30; G06F 17/24; H04L 29/08

(52) U.S. Cl. CPC G06F 17/3089; H04L 67/02; G06F 17/24

(57) ABSTRACT

Systems, methods, and related technologies for creating and deploying dynamic content experiences are described. In certain aspects, a dynamic content experience can be generated. A web page can be processed to identify an element within the web page in relation to which the content experience can be inserted. The dynamic content experience can then be inserted into the identified element.

### CROSS-REFERENCE TO RELATED APPLICATION

This application is related to and claims the benefit of U.S. Patent Application No. 62/135,152, filed Mar. 18, 2015 which is incorporated herein by reference in its entirety.

### TECHNICAL FIELD

Aspects and implementations of the present disclosure relate to content creation and delivery, and more specifically, to creating and deploying dynamic content experiences.

### BACKGROUND

Marketers, digital design and e-commerce teams often rely on a mix of specialized employees, external vendors and specialist toolsets in order to create and publish animated, rich media content on a website. The reliance on these multiple internal and external parties and systems in the creative/deployment process increases the cost, lengthens the timeframe, and increases chances of miscommunication to deploy rich media content to a website.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device generates a dynamic content experience. The processing device processes a web page to identify an element within the web page in relation to which the content experience can be inserted. The processing device inserts the dynamic content experience into the identified element.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an exemplary implementation of the disclosed technologies.

FIG. 2 depicts a flow diagram of aspects of creating an experience in accordance with one implementation of the present disclosure.

FIG. 3 depicts a graphical representation of an exemplary user interface in accordance with one implementation of the present disclosure.

FIG. 4 depicts a flow diagram of aspects of publishing an experience in accordance with one implementation of the present disclosure.

FIG. 5 depicts a graphical representation of an exemplary user interface in accordance with one implementation of the present disclosure.

FIGS. 6A-6G depict respective graphical representations of an exemplary user interfaces in accordance with various implementations of the present disclosure.

FIG. 7 depicts an illustrative system architecture in accordance with one implementation of the present disclosure.

FIG. 8 depicts an illustrative computer system in accordance with one implementation of the present disclosure.

FIG. 9 depicts further aspects of an illustrative computing device in accordance with one implementation of the present disclosure.

### DETAILED DESCRIPTION

Aspects and implementations of the present disclosure are directed to creating and deploying dynamic content experiences. The systems and methods disclosed can be employed with respect to content delivery (e.g., via web pages), among other fields. More particularly, it can be appreciated that marketers, digital design and e-commerce teams currently rely on a complicated mix of specialized employees, external vendors and specialist toolsets to create and publish animated, rich media content on their website. The reliance on these multiple internal and external parties and systems in the creative/deployment process increases the cost, lengthens the timeframe, and increases chances of miscommunication to deploy rich media content to a website. Specialist tool sets include:

(1) Content Management Systems (CMS): Such as Microsoft Sharepoint, IBM Web Content Manager, Percussion and Sitecore are typically driven by page and content templates to control uniformity of branding and layout across a website or collection of websites. One limitation of such systems is that an end-user may only create and deploy unique content that fits into pre-defined templates.

(2) Creative Platforms (CPs): Such as the Adobe Creative Suite or Adobe Experience Manager, are operated almost exclusively by highly skilled designers with additional support from equally skilled engineers. Among the shortcomings of such platforms is that the time for creative work is significant and requires multiple steps once the creative work is complete, before such creative content may be ready for deployment to a web site.

(3) Electronic Commerce Platforms: Such as Demandware, Magento, Hybris, IBM WebSphere, Oracle and others. Such platforms enable retailers to sell products or services using computer networks, such as the Internet, and draw on technologies such as mobile commerce, electronic funds transfer, supply chain management, Internet marketing, online transaction processing, electronic data interchange (EDI), inventory management systems, and automated data collection systems.

(4) Adobe Flash-based solutions are custom-built by trained developers/designers. This approach has multiple shortcomings, including the lack of ability to scale the process due to their ‘one-off’ nature, the incompatibility of Flash-based content with many smartphones and tablets.

Accordingly, there is a need for technologies to address these shortcomings, such as by providing a platform, e.g., a browser-based Software-as-a-Service (SaaS) platform, to assemble, create, animate, and publish rich media HTML5-based web experiences across multiple devices, such as Internet-enabled devices including but not limited to mobile phones, tablets or desktop devices.

The technologies described herein provide a system and method for creating and publishing content to a website, regardless of device type, without the need for skilled specialists or dependence on specialist toolsets. The technologies may, for example, be used by a marketer or digital design team to publish digital experiences to their website by means of simple configuration options and direct-to-site publishing. By supporting the end-to-end process for generalist users, the technologies enable marketers and digital design teams to build more creative digital content of higher quality and distribute that content faster than currently available systems and methods. Accordingly, it can be appreciated that the described technologies are directed to and address specific technical challenges and longstanding deficiencies in multiple technical areas, including but not limited to content creation and delivery. In addition, various implementations of the disclosed technologies provide numerous advantages and improvements upon existing approaches. For example, as noted, the described technologies can enable a broader range of user(s) to generate and distribute high quality digital content.

It is contemplated that apparatus, systems, methods, and processes of the described technologies encompass variations and adaptations developed using information from the embodiments described herein. Adaptation and/or modification of the apparatus, systems, methods, and processes described herein may be performed by those of ordinary skill in the relevant art while still remaining within the scope of the present disclosure.

Throughout the description, where apparatus and systems are described as having, including, and/or comprising specific elements and/or components, or where processes and methods are described as having, including, and/or comprising specific steps, it is contemplated that, additionally, there are apparatus and systems of the present invention that consist essentially of and/or consist of the recited components, and that there are processes and methods according to the present invention that consist essentially of and/or consist of the recited processing steps.

It should be understood that, absent words to the contrary, the order of steps or order for performing certain actions is immaterial so long as the technology remains operable. Moreover, two or more operations or actions can be conducted simultaneously.

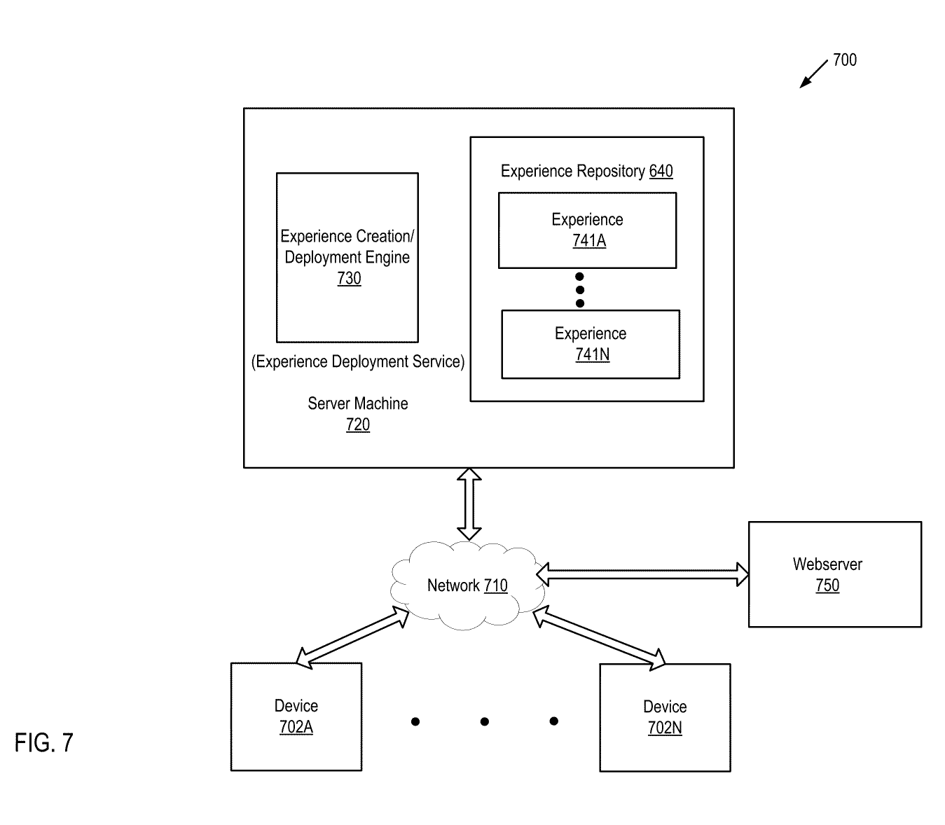

As described previously, disclosed is a system and method for a SaaS platform that enables users to easily assemble, create, animate and publish rich media based web experiences (e.g., in HTML5)—utilizing multiple publishing techniques—to a web site and/or any other such content presentation context/platform/device. Described herein are various aspects of method(s) for creating and deploying dynamic content experiences. The method(s) are performed by processing logic that may comprise hardware (circuitry, dedicated logic, etc.), software (such as is run at one or more remote devices or servers, e.g., over the Internet (also referred to as “in the Cloud”) or a dedicated machine), or a combination of both. In one implementation, the method(s) are performed by one or more elements or components depicted in FIG. 7, while in some other implementations one or more blocks depicted in the various figures may be performed by another machine.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

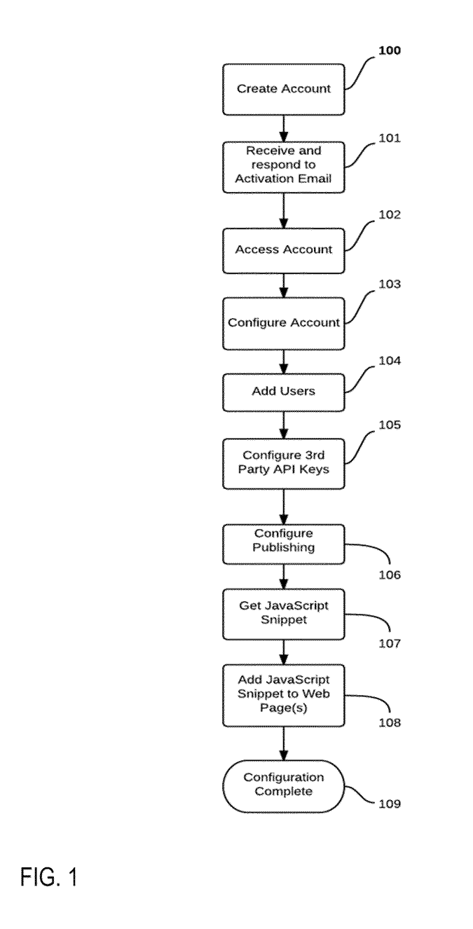

FIG. 1 depicts an exemplary implementation of the referenced technologies. It should be understood that the various operations depicted in FIG. 1 and/or described herein can be performed by server machine 720 (e.g., in conjunction with experience creation/deployment engine 730), device(s) 702, webserver 750, and or via a combination of the referenced elements (e.g., two or more devices in communication with one another). As shown in FIG. 1, the initial account creation and configuration process where an account and user ID(s) can be created for one or more users [block 100]. Once activated, new users can be provided with a welcome email with a link to log into their account [block 101]. Upon receipt of the welcome email, said new user may click on link to activate an online account [block 102].

Once the initial base account setup is complete [block 102], the user may then proceed in configuring the account further [block 103]. Additional users to a customer's account may be invited and/or created by inputting the additional information, such as a user's name, email address and/or desired level of permission [block 104]. In the configuration of third party API keys [block 105], the user may input and activate any third-party application programming interface (API) keys, including without limitation, Google Universal Analytics, Segment.com, TypeKit.com, or others, to establish communication with other platforms of the user's choosing. In the configure publishing [block 106], the user may retrieve a JavaScript Snippet [block 107] to place on a webpage in order to enable drag and drop publishing. Subsequently, the user may then add the JavaScript Snippet to a webpage or webpages where the user intends to publish an experience [block 108]. At this point, the configuration process is complete [block 109].

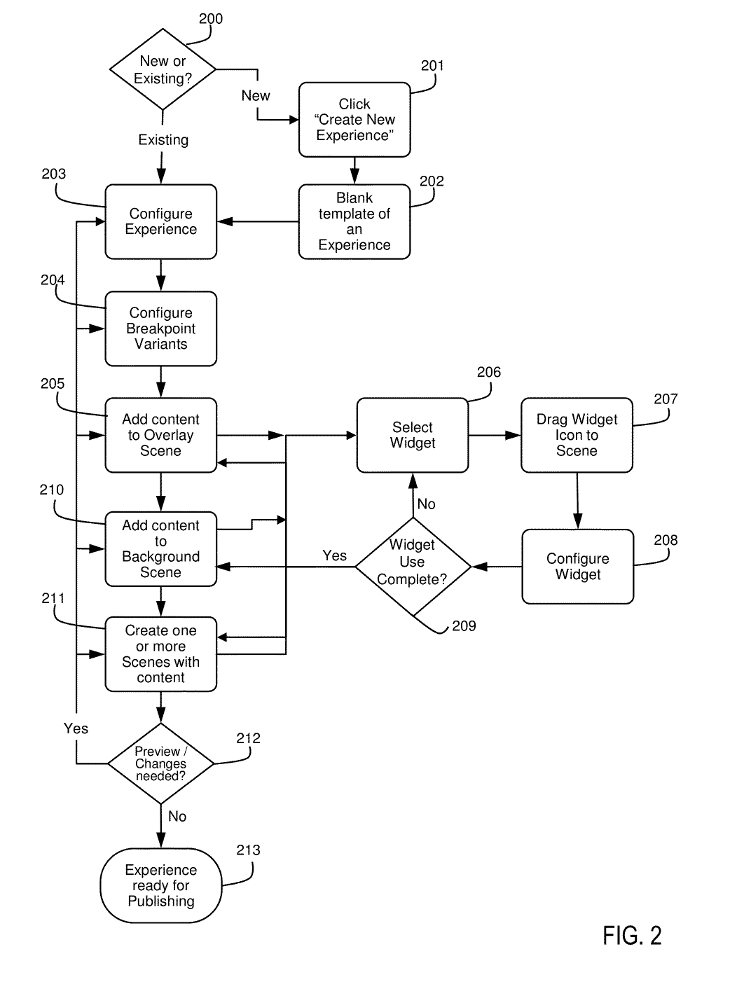

FIG. 2 depicts an implementation of the described technologies which includes the process of creating an experience [block 200]. It should be understood that the various operations depicted in FIG. 2 and/or described herein can be performed by server machine 720 (e.g., in conjunction with experience creation/deployment engine 730), device(s) 702, webserver 750, and or via a combination of the referenced elements (e.g., two or more devices in communication with one another). In certain implementations, the user may select “Create New Experience” [block 201] (e.g., via a graphical user interface (GUI) provided by server 720 and/or presented at device 702, e.g., via a web browser) which may open the user interface with an empty template ready for use [block 202]. Subsequently, the user may build and configure the experience by providing various inputs via the interface, such as is described herein [block 203]. In certain implementations, configuration options may include naming the experience, selecting various parameters, settings, etc., associated with the experience, such as the height and width of each section of an experience, the number of sections or scenes to an experience, any desired transitions between scenes, including without limitation auto-transition, timing and type of transition (none, slide, fade) and more. Subsequent to configuring the experience, the user may configure additional breakpoint variants [block 204] for presenting an ‘omnichannel’ experience. Such an omnichannel experience can be an experience designed for a responsive presentation across mobile, tablet and/or desktop (or other) devices in various orientations, such as landscape or portrait. Subsequent to configuring the breakpoint variants, the user may start building out the layered content of the experience. There are various layers available such as: overlay scene [block 205], background scene [block 210] and general scene [block 211].

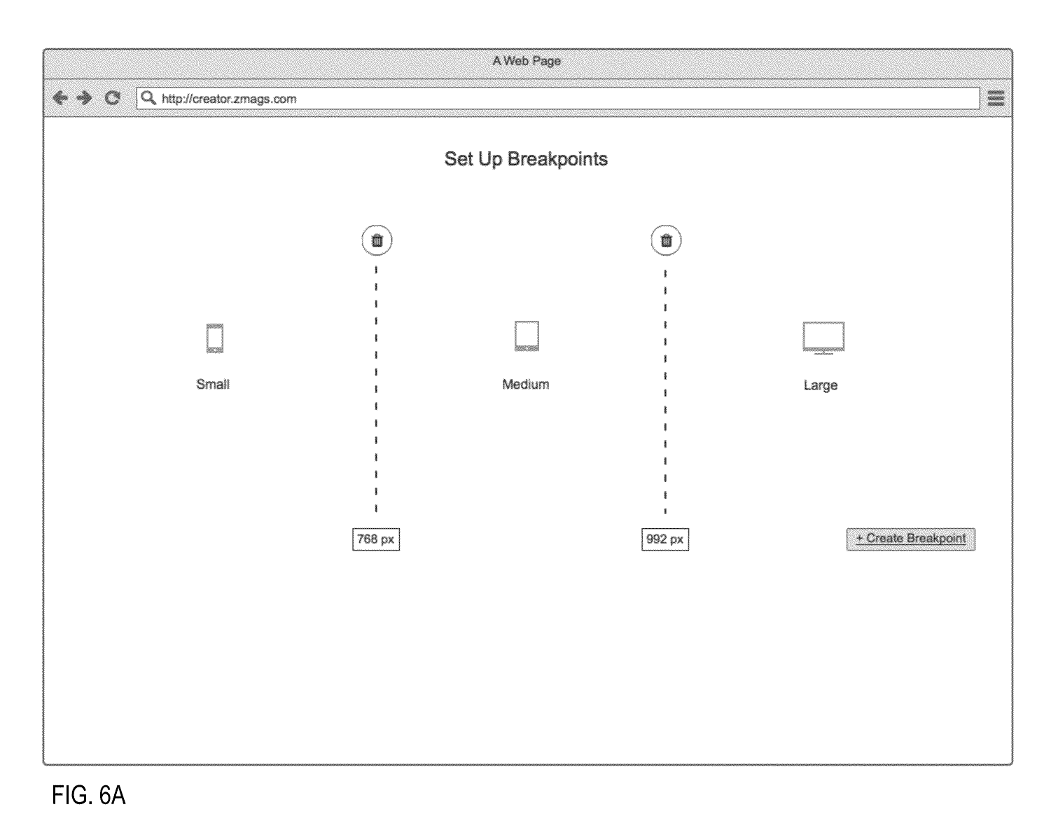

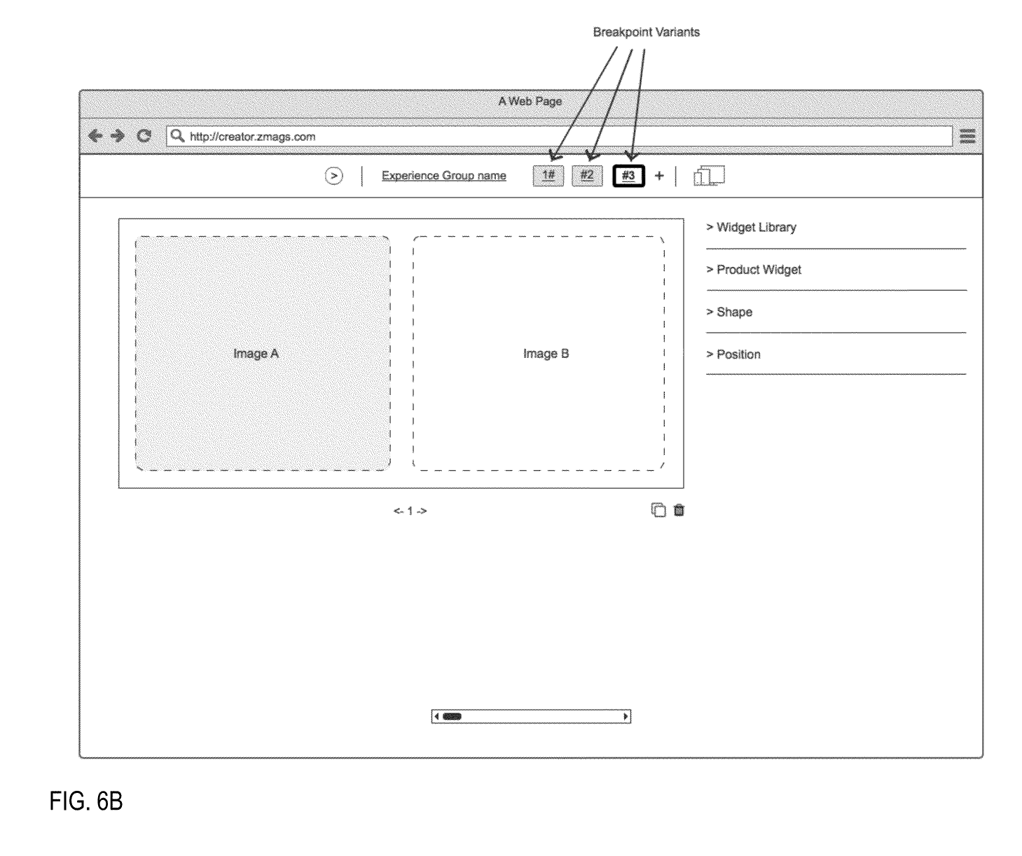

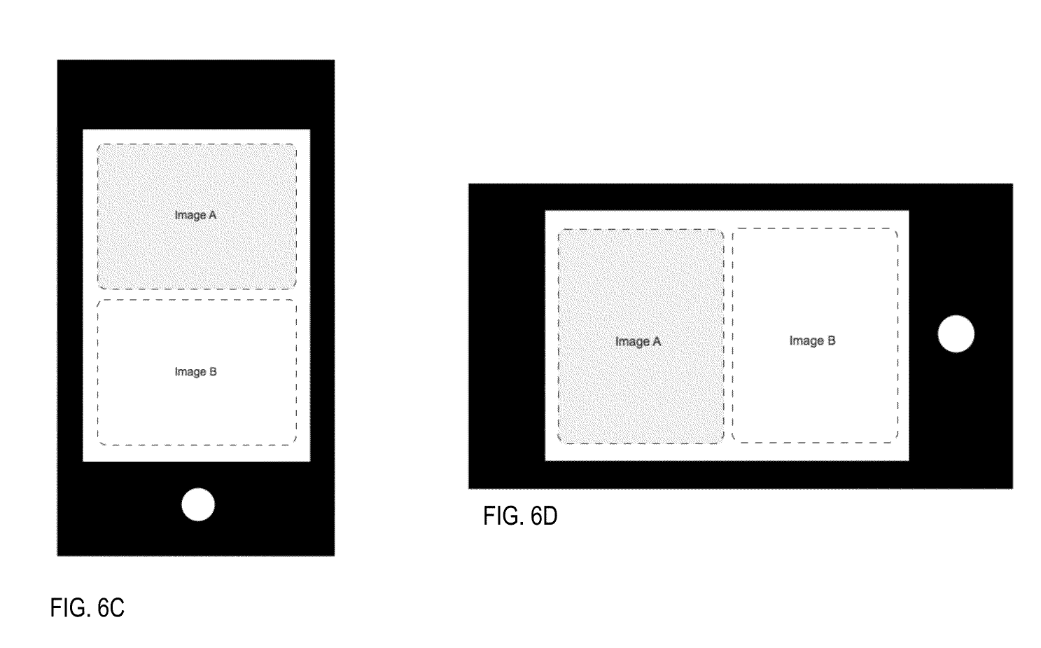

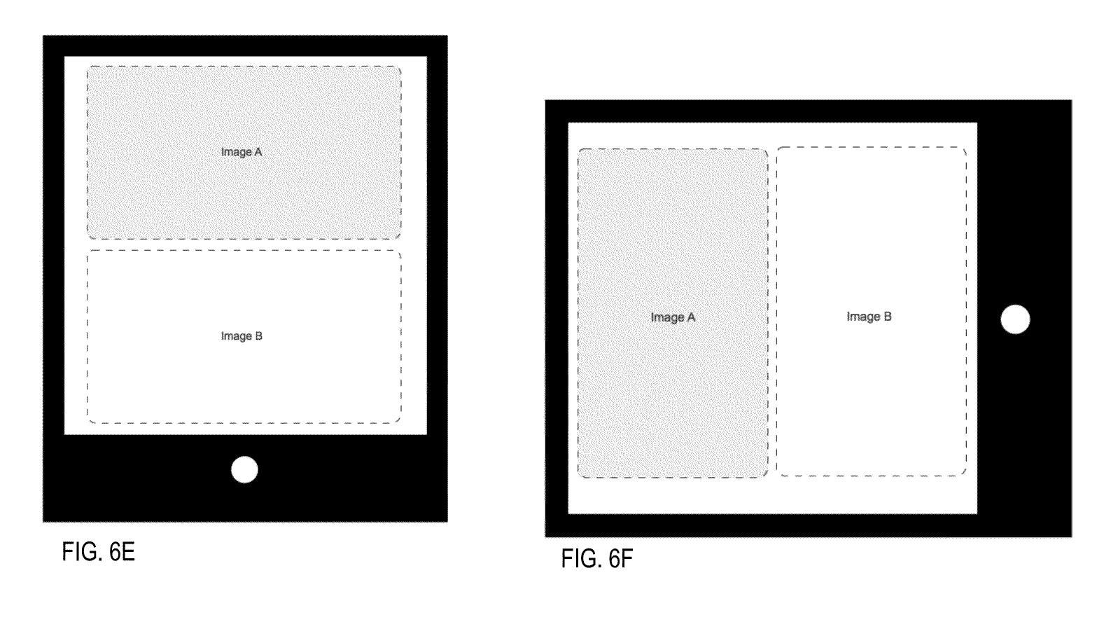

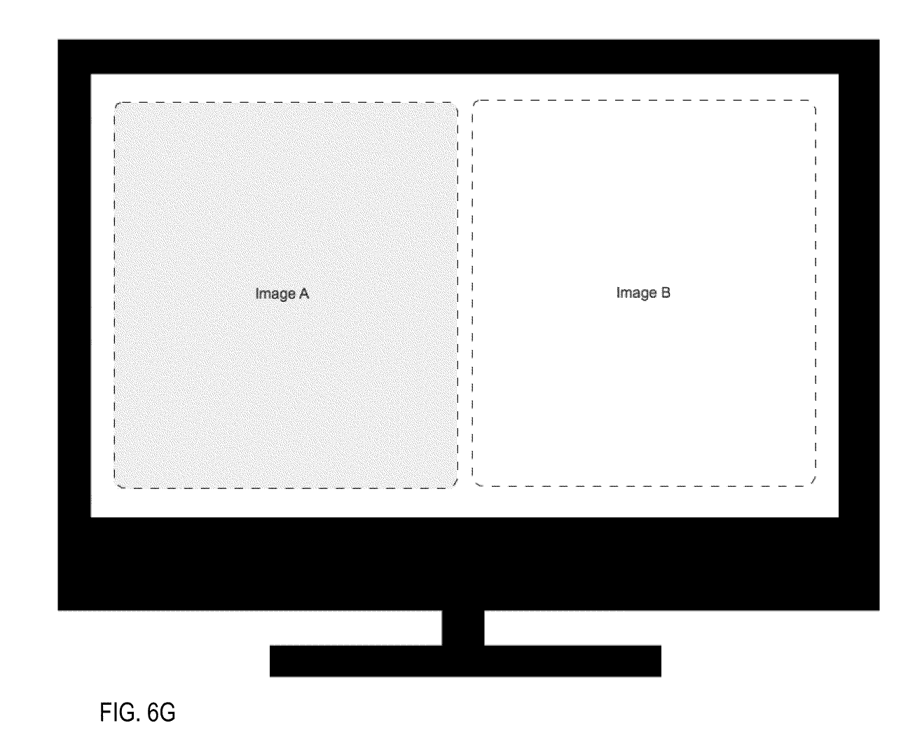

During the configuration of breakpoint variants [block 204], a user can configure an experience based on breakpoint variants based on screen size (as defined, for example, as height and width). For the user working within one experience, this may include, by way of example and without limitation, establishing one breakpoint variant with height and width dimensions based on pixels or percentage of screen size for, by way of example and without limitation, a mobile device held vertically (referred to as being in ‘portrait’ mode), a second breakpoint variant for the same scene with different height and width dimensions based on pixels or percentage of screen size for, by way of example and without limitation, a mobile device held horizontally (referred to as being in ‘landscape’ mode), a third breakpoint variant for the same scene with different height and width dimensions based on pixels or percentage of screen size for, by way of example and without limitation, a tablet device held vertically, a fourth breakpoint variant for the same scene with different height and width dimensions based on pixels or percentage of screen size for, by way of example and without limitation, a tablet device held horizontally and a fifth breakpoint variant for the same scene with different height and width dimensions based on pixels or percentage of screen size for, by way of example and without limitation, a desktop device. During the breakpoint variant configuration process, a user can have different names for each variant. Configuring breakpoint variants can ensure that once an experience is ‘live’ and available for public consumption, the experience variant appropriate to the screen size is presented. Further aspects of the configuration of the referenced breakpoint variants are described below with respect to FIGS. 6A-6G.

In the overlay scene [block 205], a user can place content that should be visible in the top layer across one or more scenes in an experience, including by way of example and without limitation, the navigation elements, an image of a company logo, or one or more social networking links or icons which may be associated with various social networking services such as Facebook, Twitter, Instagram or others. In the background scene [block 210], the user may place content that should be visible in the lowest layer across all scenes in an experience, including by way of example and without limitation, a background image such as a corporate logo, specific text, or a link that is to be present on all scenes.

A user may also create one or more general scenes [block 211] with appropriate content to compose the flow of the experience. By way of example and without limitation, the first general scene in an experience may contain a cover page to a Spring season lookbook for an upscale handbag manufacturer, and the second general scene may hold additional relevant content, such as a selection of two handbags. This may be repeated for a third scene, a fourth scene and so on. An experience may have one or as many scenes as developed by a user.

For further clarification, and without limitation, in each of the overlay [block 205], background [block 210], and general scenes [block 211], a user may use widgets [blocks 206, 207, 208 and 209] to add, position and configure content.

A widget can be a tool used to add digital content to a scene. To use a widget, the user selects an appropriate widget [block 206], then drags the widget (e.g., as depicted in a user interface) to the scene from the widget menu [block 207], and then configures it using a set of options which may be specific to that widget [block 208].

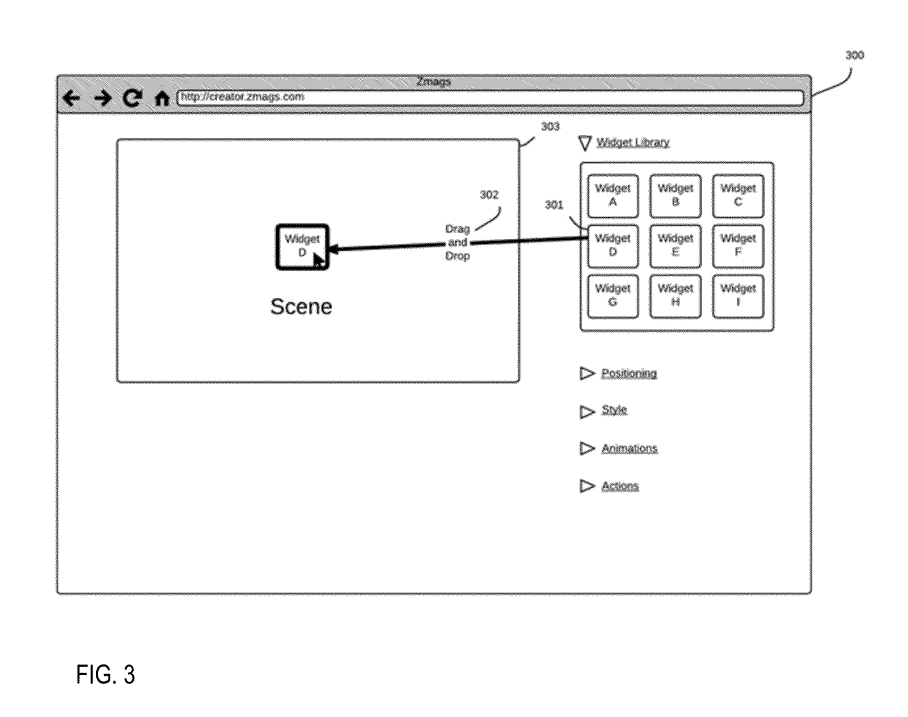

FIG. 3 depicts a graphical representation of an exemplary user interface [300] (e.g., as may be provided by server 720 and depicted/presented at device 702) reflecting aspects of the process of a user using the pointer in the graphical user interface. It should be understood that the referenced pointer may be controlled by a mouse, touchscreen, keyboard, and/or any other such input device, e.g., in order to select one or more widget(s) [301], and subsequently drag-and-drop [302] a widget icon from a widget bar or library (e.g., as shown on the right side of user interface 300) and drop the selected widget, for example, into an overlay, background, or general scene [303] layer.

It should be understood that the referenced widgets also may have both shared and unique functionalities. In certain implementations, widgets can share the functionalities such as:

Positioning: This function configures the widget position on a scene in pixels (e.g., as measured from top left corner), rotation (e.g., in degrees), size in pixels (e.g., height×width), position within layer (e.g., forward, backward, to front, to back), or proportional fit within a scene.

Style: The widget may have stroke or border and drop shadow with selectable weight and color applied.

Animations may be applied and may initiate based on overall scene timing. Without limitation, these may include:

Slide in/out: direction, easing, delay, time.

Fade in/out: easing, delay, time.

Zoom in/out: easing, delay, time.

Move: Direction (in pixels), easing, delay, time.

Actions may also be applied to widgets and may be triggered when the consumer/viewer of an experience clicks or tabs on the widget. Such actions may, without limitation, include commands, such as to open link in new window/tab or current window/tab, run JavaScript code, open link in lightbox and set size for lightbox, or navigate scenes (scene #, next, previous, etc.).

Widgets may also be copied and pasted into other scenes. The content and settings of the widget may be retained after pasting.

Certain functionalities of a widget may be specific to that widget only. By way of example and without limitation, this may include widgets such as:

Media player (e.g., YouTube) widget controls that may enable and control options of a streaming video in an experience such as: autoplay, loop, enable video player controls, and access to add videos from a user account (if logged in).

In this certain implementations, by way of example and without limitation, widgets may include the following:

A text widget that may enable the adding of optional text to an experience and contains the following options: color, font size, line height, standard or custom web fonts, font style, or alignment (left, center, right).

An image widget that may enable the adding of images to an experience and may contains the following options: upload image from folder, add single or multiple images to a scene from the image library or desktop via drag and drop upload, drag and drop single or multiple images from the user's desktop folder directly to the image library, search/sort images in the image library.

A link widget that may enable the adding of a clickable hotspot that can cover an area on the scene and make that area clickable by the consumer.

An ecommerce widget that may enable the addition of detailed product information to appear in a lightbox with add-to-cart functionality. Such detailed product information may be sourced from the electronic commerce platform and may include, by way of example and without limitation, color, sizing, description, stock images or video and other information residing on the electronic commerce platform. Add-to-cart functionality may include, by way of example and without limitation, the ability for the end consumer to add the product to their shopping cart for future purchase.

When working within a scene overlay [block 204], background [block 209], or general scenes [block 210], the user decides if they do or do not need additional widgets or to configure (or reconfigure) those widgets currently used in the scene [block 208], and then acts accordingly to use additional widgets [blocks 205, 206 and 207], or moves on to the appropriate next step [blocks 204, 209 or 210].

In certain implementations, during or after the creation of an experience, a user may preview [block 211] the final presentation of an experience, and upon review decide to make iterative updates or changes to an experience, including without limitation its configuration, content, or detail in the overlay, background and general scene layers. Once a user is satisfied with the quality of the experience, the experience may then be ready for publication [block 212].

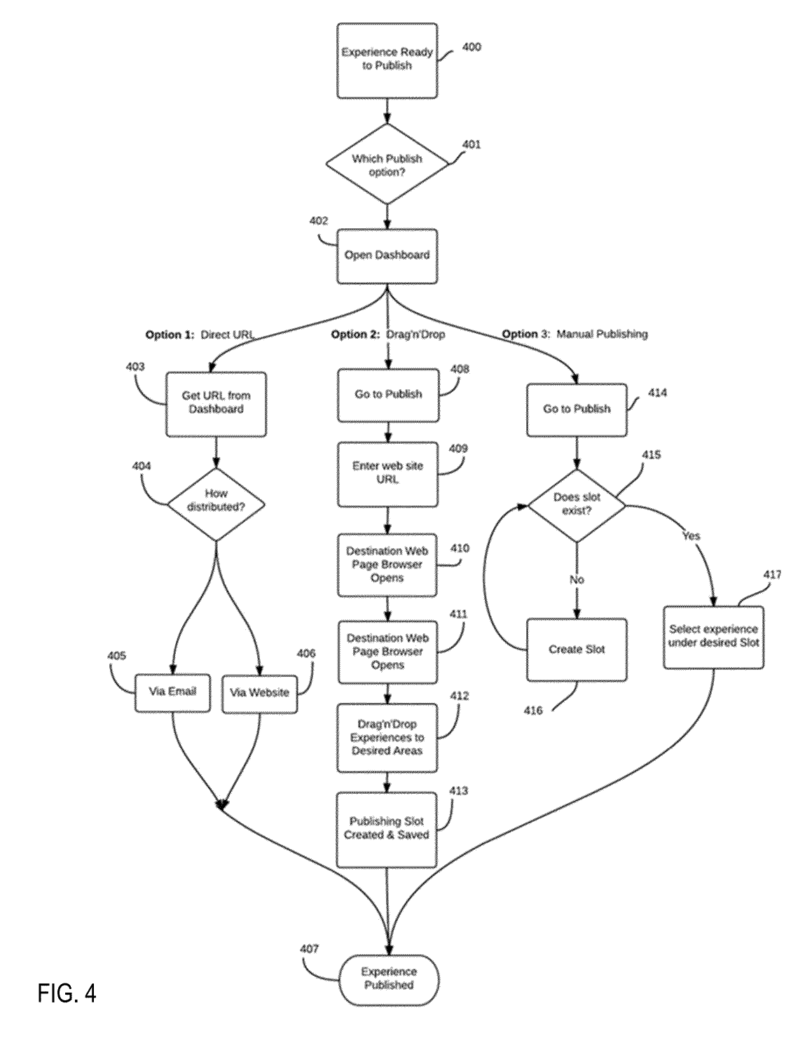

FIG. 4 depicts various aspects of a process relating to publishing an experience [block 400]. It should be understood that the various operations depicted in FIG. 4 and/or described herein can be performed by server machine 720 (e.g., in conjunction with experience creation/deployment engine 730), device(s) 702, webserver 750, and or via a combination of the referenced elements (e.g., two or more devices in communication with one another). An experience may be published in various ways, such as: (1) publishing of a direct URL (universal resource locator) link for distribution via an email or a link on a web page, (2) “drag and drop” publishing directly from the referenced user interface to a web page and/or (3) manual publishing directly to a section or “slot” on a web page.

In certain implementations, the user may first select a way to publish [block 401] out of the options available.

In certain implementations, with respect to publishing an experience via a direct URL, the user may navigate to the Dashboard section [block 402] of the platform and, after selecting an experience of their choosing, then choose to retrieve the direct URL for an experience [block 403]. The direct URL may then, at the option of the user [block 404], be distributed to a consumer/viewer via, for example and without limitation, a link in an email [block 405] or a link or element (for example, an iFrame element) in a web page [block 406] from which the consumer may be able to access the experience in a web browser [block 407].

In certain implementations, with respect to publishing an experience via drag-and-drop, the user may navigate to the dashboard section [block 402], then select ‘Go to Publish’ [block 408]. The user may then input the URL of the website to which they intend to publish [block 409]. Upon receipt and user acknowledgement of the inputted URL, the destination web page may then open [block 410] in a separate web browser window and a separate, adjacent, browser window also may open and be loaded with the user's experience(s) shown [block 411]. Subsequently, provided the previously provided JavaScript Snippet [block 107] has been placed on a webpage (or web pages) provided by the user, the user may now select an experience from the experience browser window via a click of the pointer in the graphical user interface (e.g., via a mouse, touchscreen, etc.), and may then drag the experience onto the website browser window [block 412], and upon release of mouse button (or “drop”) of the experience in the HTML div element on the destination webpage [block 412], a publishing slot may be created on that page and the experience may be added to the publishing slot. At this point, the user may choose to “save” the experience and publishing slot configuration [block 413], which allows the experience to go-live on the website for public consumption [block 407]. If an experience is live and available for public consumption and the breakpoint variants are configured [block 204], then the platform presents the experience variant appropriate to the screen size when viewed during public consumption [block 407]. Subsequently, any experience saved in a publishing slot may later be replaced with another experience by dragging a new experience to the publishing slot and clicking “save” [block 413].

As shown with respect to FIG. 4, in certain implementations, for the purpose of manual publishing, the user may navigate to the Dashboard section [block 402], then select Go to Publish [block 414]. Subsequently, the user may navigate to the manual publishing List. If the publishing slot for the desired webpage already exists [block 415], the user may select via a drop down list, the experience intended for publishing in the slot [block 417]. If the Publishing slot does not currently exist for a desired location to publish, the user may create the slot manually [block 416], by inserting a title, CSS (cascading style sheet) Selector, and URL, and may subsequently save the slot, and then select, via a drop down list [block 417] the experience intended for publishing in the slot. If the user wishes to publish an experience(s) to multiple URL's, this may be achieved by adding an asterisk (referred to as “wildcards” in this one embodiment) (“*”) to the URL in any of the following configurations www.somesite.com/sectionl* which would target any page under section 1. www.somesite.com/*/subsection which would target all subsection pages across a website.

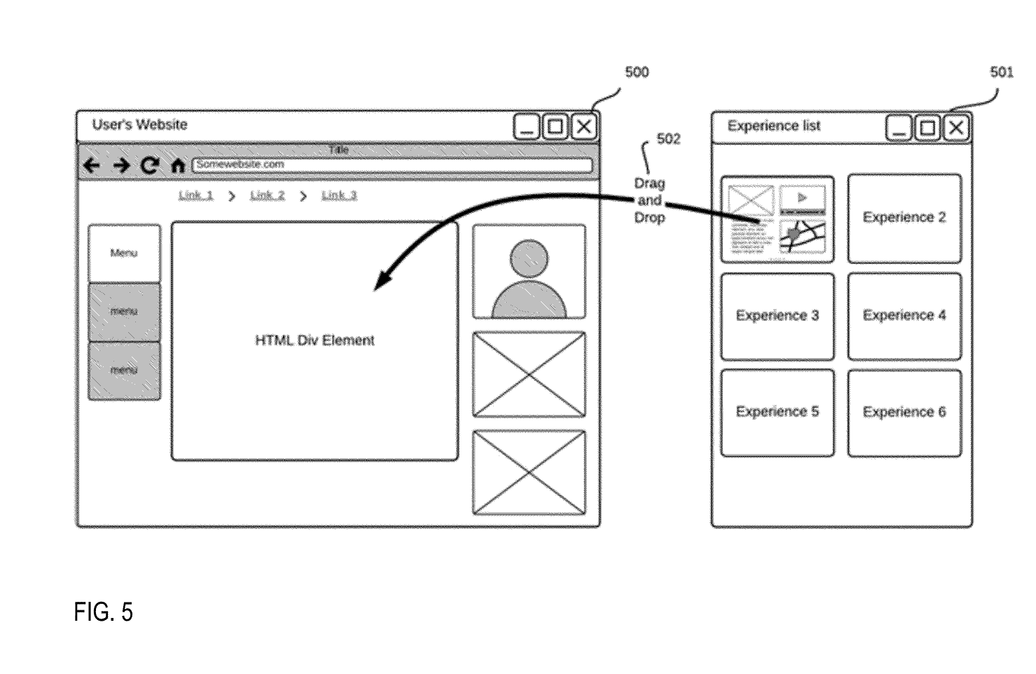

FIG. 5 depicts an exemplary user interface of an open destination web page [500] and an open separate, adjacent, browser window be loaded with the user's experience(s) shown [501] (e.g., as may be provided by server 720 and depicted/presented at device 702). Also depicted in FIG. 5 are various aspects of operation(s) pertaining to dragging and releasing [502] an experience from an open window loaded with the user's experiences [501] to the destination HTML div element of the experience on the destination webpage [500]. Moreover, in certain implementations various aspects of an experience can be modified or adjusted, such as based on aspects of the web page element in relation to which the experience is being inserted/applied. For example, while an experience may initially be designed in one aspect ratio, upon insertion of the experience into a web page element having a different ratio, the experience can be modified/adjusted to conform to the web page element into which it is inserted.

Additionally, in certain implementations, in scenarios in which multiple experiences are available for insertion (such as is depicted in FIG. 5), various aspects of the respective experiences can be analyzed (e.g. their native dimensions/aspect ratios), and such aspects can be compared to various aspect of a web page into which such experiences are eligible for insertion (e.g., the web page depicted in FIG. 5). In doing so, one or more suggestions or recommendations can be generated, such as with respect to which experience is likely to be advantageously deployed in which web page element (e.g., based on the degree to which the original aspect ratio of the experience is maintained). Moreover, in certain implementations various experiences can be populated into a web page in an automated fashion, such as based on the degree to which the aspect ratio of a particular experience is maintained when inserted into a particular web page element.

It should also be noted that, in certain implementations, multiple experiences can be inserted into a single web page element (e.g., by overlaying one experience upon another).

FIGS. 6A and 6B depict exemplary user interfaces (e.g., as may be provided by server 720 and depicted/presented at device 702) of one configuration process as described previously with respect to the Breakpoint Variant configuration [block 204] during which the user has the ability to name the various configurations and to assign them to a screen size. FIG. 6C depicts the presentation of one experience on a screen for a mobile device oriented vertically while FIG. 6D depicts the presentation of that same experience on a screen of a mobile device oriented horizontally. FIG. 6E and FIG. 6F depict the presentation of that same experience on a screen for a tablet device oriented vertically and horizontally, respectively. FIG. 6G depicts the presentation of the same experience on a desktop screen.

FIG. 7 depicts an illustrative system architecture 700 for creating and deploying dynamic content experiences, in accordance with one implementation of the present disclosure. The system architecture 700 includes user devices 702A-702N, server machine 720, and webserver 750. These various elements or components can be connected to one another via network 710, which can be a public network (e.g., the Internet), a private network (e.g., a local area network (LAN) or wide area network (WAN)), or a combination thereof.

User devices 702A-702N can be wireless terminals (e.g., smartphones, etc.), personal computers (PC), laptops, tablet computers, or any other computing or communication devices capable of implementing the various features described herein. The user devices 702A-702N may run an operating system (OS) that manages hardware and software of the user devices 702A-702N. Various applications, such as mobile applications (‘apps’), web browsers, etc. may run on the client machines (e.g., on the OS of the client machines). Such applications can, for example, enable a user to create, transmit, and/or receive electronic content (e.g., webpages, etc.) and/or other content, such as in a manner known to those of ordinary skill in the art. The user devices 702A-702N can be geographically distributed anywhere throughout the world.

Server machine 720 can be a rackmount server, a router computer, a personal computer, a portable digital assistant, a mobile phone, a laptop computer, a tablet computer, a netbook, a desktop computer, a media center, any combination of the above, or any other such computing device capable of implementing the various features described herein. Server machine 720 can include components such as experience creation/deployment engine 730, and experience repository 740. The components can be combined together or separated in further components, according to a particular implementation. It should be noted that in some implementations, various components of server machine 720 may run on separate machines. Moreover, some operations of certain of the components are described in more detail herein with respect to FIGS. 1-6G.

Experience repository 740 can be hosted by one or more storage devices, such as main memory, magnetic or optical storage based disks, tapes or hard drives, NAS, SAN, and so forth. In some implementations, experience repository 740 can be a network-attached file server, while in other implementations experience repository 740 can be some other type of persistent storage such as an object-oriented database, a relational database, and so forth, that may be hosted by the server machine 720 or one or more different machines coupled to the server machine 720 via the network 710, while in yet other implementations experience repository 740 may be a database that is hosted by another entity and made accessible to server machine 720.

Experience repository 740 can include experiences 741A-741N, such as those described and referenced herein and/or any other such related content (e.g., documents, files, media, etc.). As described herein, an experience can be created by a user (e.g., via device 702A) and can be provided to another user (e.g., a viewer) (e.g., via device 702N) in conjunction with a website or web content (e.g., as provided by webserver 750). In certain implementations, one or more of such operations can be performed by and/or in conjunction with experience creation/deployment engine 730, as described herein.

It should also be noted that while the technologies described herein are illustrated primarily with respect to creating and deploying dynamic content experiences, such as with respect to websites and other content presentation interfaces, the described technologies can also be implemented in any number of additional or alternative settings or contexts and towards any number of additional objectives.

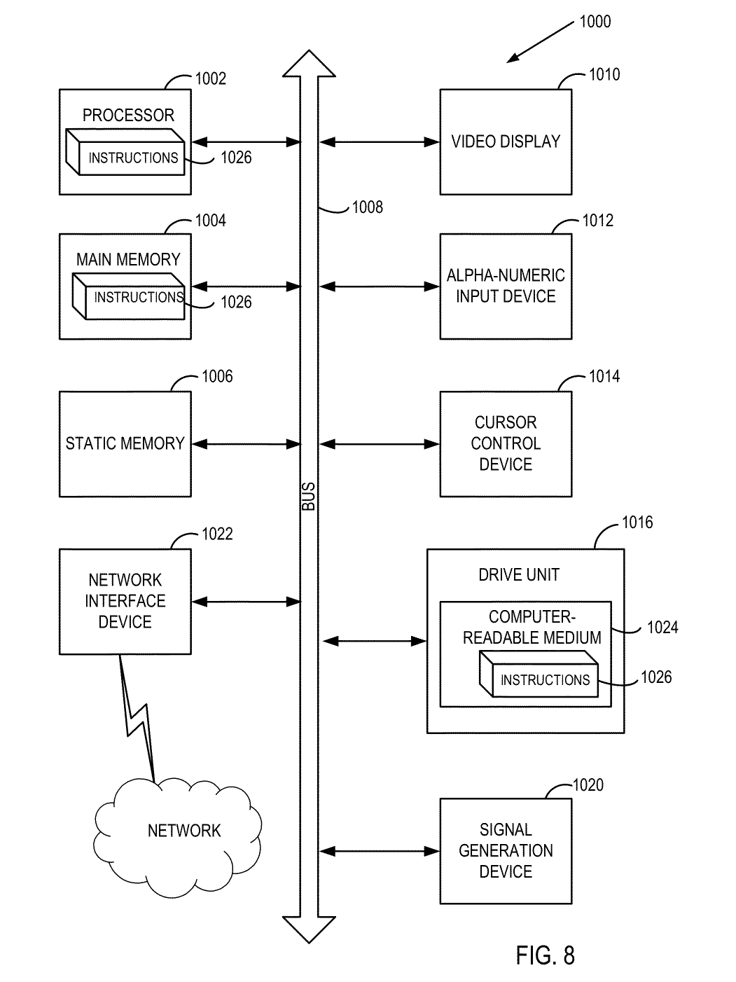

FIG. 8 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 includes a processing system (processor) 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)), and a data storage device 1016, which communicate with each other via a bus 1008.

Processor 1002 represents one or more processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 may also be one or more special-purpose processing devices such as an application specific integrated circuit (ASIC), a field programmable gate array (FPGA), a digital signal processor (DSP), network processor, or the like. The processor 1002 is configured to execute instructions 1026 for performing the operations and steps discussed herein.

The computer system 1000 may further include a network interface device 1022. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1020 (e.g., a speaker).

The data storage device 1016 may include a computer-readable medium 1024 on which is stored one or more sets of instructions 1026 embodying any one or more of the methodologies or functions described herein. Instructions 1026 may also reside, completely or at least partially, within the main memory 1004 and/or within the processor 1002 during execution thereof by the computer system 1000, the main memory 1004 and the processor 1002 also constituting computer-readable media. Instructions 1026 may further be transmitted or received over a network via the network interface device 1022.

While the computer-readable storage medium 1024 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

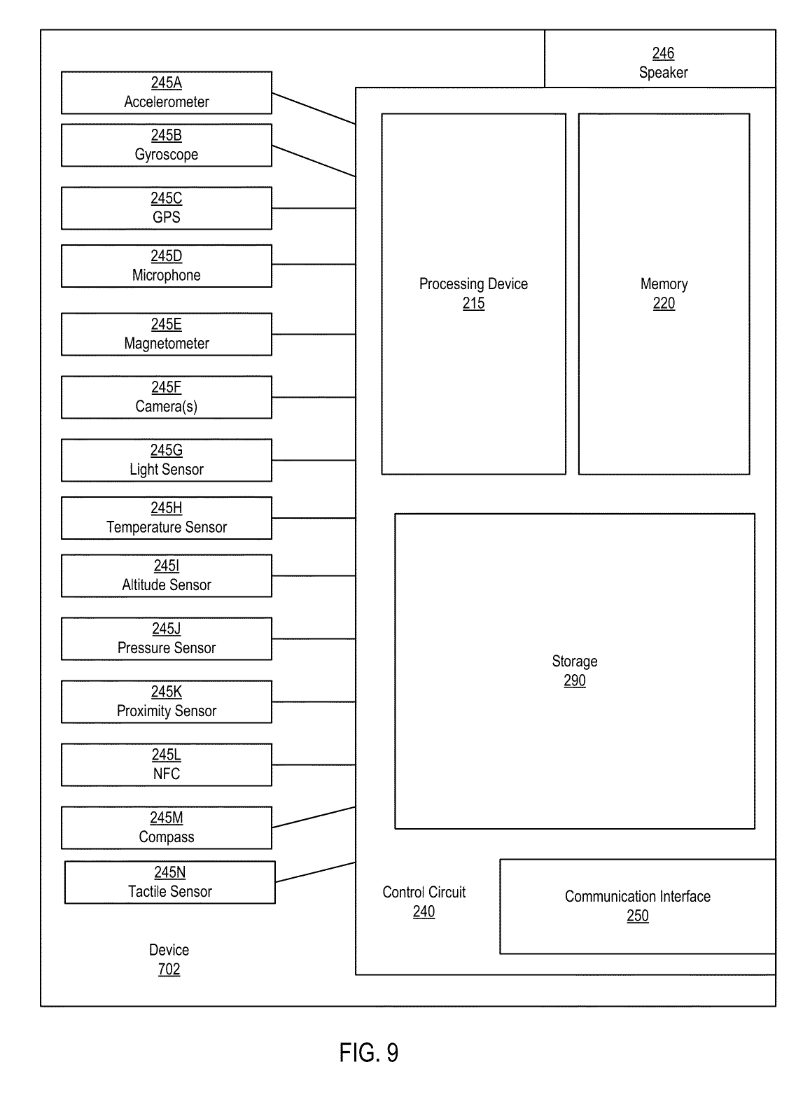

FIG. 9 depicts further aspects of a computing device 702 that can be configured to implement one or more of the technologies or techniques described herein. Device 702 can be a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer or system, any combination of the above, or any other such computing device capable of implementing the various features described herein. Various applications, such as mobile applications (‘apps’), web browsers, etc. (not shown) may run on the user device (e.g., on the operating system of the user device). It should be understood that, in certain implementations, user device 702 can also include or incorporate various sensors or communications interfaces. Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, Wi-Fi interface, USB interface, NFC interface, etc.

As noted, in certain implementations, user device(s) 702 can also include or incorporate various sensors or communications interfaces. By way of illustration, FIG. 9 depicts one exemplary implementation of user device 702. As shown in FIG. 4, device 702 can include a control circuit 240 (e.g., a motherboard) which is operatively connected to various hardware or software components that serve to enable various operations, such as those described herein. Control circuit 240 can be operatively connected to processing device 215 and memory 220. Processing device 215 serves to execute instructions for software that can be loaded into memory 220. Processing device 215 can be a number of processors, a multi-processor core, or some other type of processing device, depending on the particular implementation. Further, processing device 215 can be implemented using a number of heterogeneous processor systems in which a main processor is present with secondary processors on a single chip. As another illustrative example, processing device 215 can be a symmetric multi-processor system containing multiple processing devices of the same type.

Memory 220 and storage 290 may be accessible by processing device 215, thereby enabling processing device 215 to receive and execute instructions stored on memory 220 and on storage 290. Memory 220 can be, for example, a random access memory (RAM) or any other suitable volatile or non-volatile computer readable storage medium. In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above. Storage 290 also can be fixed or removable.

A communication interface 250 is also operatively connected to control circuit 240. Communication interface 250 can be any interface (or multiple interfaces) that enables communication between user device 702 and one or more external devices, machines, services, systems, or elements. Communication interface 250 can include (but is not limited to) a modem, a Network Interface Card (NIC), an integrated network interface, a radio frequency transmitter or receiver (e.g., Wi-Fi, Bluetooth, cellular, NFC), a satellite communication transmitter or receiver, an infrared port, a USB connection, or any other such interfaces for connecting device 702 to other computing devices, systems, services, or communication networks such as the Internet. Such connections can include a wired connection or a wireless connection (e.g. 802.11) though it should be understood that communication interface 250 can be practically any interface that enables communication to or from the control circuit 240 or the various components described herein.

At various points during the operation of described technologies, device 702 can communicate with one or more other devices, systems, services, servers, etc., such as those depicted in the accompanying figures and described herein. Such devices, systems, services, servers, etc., can transmit and receive data to or from the user device 702, thereby enhancing the operation of the described technologies, such as is described in detail herein. It should be understood that the referenced devices, systems, services, servers, etc., can be in direct communication with user device 702, indirect communication with user device 702, constant or ongoing communication with user device 702, periodic communication with user device 702, or can be communicatively coordinated with user device 702, as described herein.

Also preferably connected to or in communication with control circuit 240 of user device 702 are one or more sensors 245A-245N (collectively, sensors 245). Sensors 245 can be various components, devices, or receivers that can be incorporated or integrated within or in communication with user device 702. Sensors 245 can be configured to detect one or more stimuli, phenomena, or any other such inputs, described herein. Examples of such sensors 245 include, but are not limited to, an accelerometer 245A, a gyroscope 245B, a GPS receiver 245C, a microphone 245D, a magnetometer 245E, a camera 245F, a light sensor 245G, a temperature sensor 245H, an altitude sensor 2451, a pressure sensor 245J, a proximity sensor 245K, a near-field communication (NFC) device 245L, a compass 245M, and a tactile sensor 245N. As described herein, device 702 can perceive or receive various inputs from sensors 245 and such inputs can be used to initiate, enable, or enhance various operations or aspects thereof, such as is described herein.

At this juncture it should be noted that while the foregoing description (e.g., with respect to sensors 245) has been directed to user device 702, various other devices, systems, servers, services, etc. (such as are depicted in the accompanying figures and described herein) can similarly incorporate the components, elements, or capabilities described with respect to user device 702. For example, various devices depicted as part of system architecture 700 may also incorporate one or more of the referenced components, elements, or capabilities.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “providing,” “precluding,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a computing device selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

What is claimed is:

1. A method comprising:
generating a dynamic content experience;
processing, by a processing device, a web page to identify an element within the web page in relation to which the content experience can be inserted; and
inserting the dynamic content experience into the identified element.

2. The method of claim 1, wherein generating the dynamic content experience comprises receiving one or more parameters associated with the dynamic content.

3. The method of claim 2, wherein the dynamic content experience comprises one or more sections and wherein the one or more parameters comprises at least one of a height of at least one of the one or more sections, a width of at least one of the one or more sections, or a quantity of sections within the experience.

4. The method of claim 2, wherein the dynamic content experience comprises one or more scenes and wherein the one or more parameters comprises one or more transitions between the one or more scenes.

5. The method of claim 2, wherein generating the dynamic content experience comprises generating the dynamic content experience based on the one or more parameters.

6. The method of claim 1, further comprising receiving a configuration of one or more breakpoint variants associated with the dynamic content experience.

7. The method of claim 6, wherein the configuration of the one or more breakpoint variants corresponds to a configuration of the dynamic content experience in view of one or more dimensions of a screen at which the dynamic content experience is to be presented.

8. The method of claim 1, wherein processing the web page further comprises processing one or more dynamic content experiences to determine which of the one or more dynamic content experiences are eligible for insertion within the element of the web page.

9. The method of claim 8, wherein processing the web page further comprises comparing one or more dimensions of the one or more dynamic content experiences with one or more dimensions of the element of the web page to determine which of the one or more dynamic content experiences are eligible for insertion within the element of the web page.

10. The method of claim 8, wherein processing the web page further comprises comparing one or more respective aspect ratios of the one or more dynamic content experiences with an aspect ratio of the element of the web page to determine which of the one or more dynamic content experiences are eligible for insertion within the element of the web page.

11. The method of claim 10, wherein processing the web page further comprises generating a recommendation with respect to at least one of the one or more dynamic content experiences based on a degree to which an aspect ratio associated with the at least one of the one or more dynamic content experiences is maintained when inserted within the element of the web page.

12. The method of claim 1, wherein inserting the dynamic content experience comprises inserting a JavaScript snippet that corresponds to the dynamic content experience into the web page.

13. A system comprising:
a memory; and
a processing device, operatively coupled to the memory, to:
generate a dynamic content experience;
process a web page to identify an element within the web page in relation to which the content experience can be inserted; and
insert the dynamic content experience into the identified element.

14. The system of claim 13, wherein the processing device is further to receive a configuration of one or more breakpoint variants associated with the dynamic content experience, wherein the configuration of the one or more breakpoint variants corresponds to a configuration of the dynamic content experience in view of one or more dimensions of a screen at which the dynamic content experience is to be presented.

15. The method of claim 13, wherein processing the web page further comprises processing one or more dynamic content experiences to determine which of the one or more dynamic content experiences are eligible for insertion within the element of the web page.

16. The method of claim 15, wherein to process the web the processing device is further to compare one or more dimensions of the one or more dynamic content experiences with one or more dimensions of the element of the web page to determine which of the one or more dynamic content experiences are eligible for insertion within the element of the web page.

17. The method of claim 15, wherein to process the web page the processing device is further to compare one or more respective aspect ratios of the one or more dynamic content experiences with an aspect ratio of the element of the web page to determine which of the one or more dynamic content experiences are eligible for insertion within the element of the web page.

18. The method of claim 17, wherein to process the web page the processing device is further to generate a recommendation with respect to at least one of the one or more dynamic content experiences based on a degree to which an aspect ratio associated with the at least one of the one or more dynamic content experiences is maintained when inserted within the element of the web page.

19. The method of claim 13, wherein to insert the dynamic content experience the processing device is further to insert a JavaScript snippet that corresponds to the dynamic content experience into the web page.

20. A non-transitory computer readable medium having instructions stored thereon that, when executed by a processing device, cause the processing device to:
generate a dynamic content experience;
compare, by the processing device, an aspect ratio of the dynamic content experience with an aspect ratio of an element within a web page in relation to which the content experience can be inserted to determine a degree to which the aspect ratio of the dynamic content experience is maintained when inserted within the element of the web page; and
based on the degree to which the aspect ratio of the dynamic content experience is maintained when inserted within the element of the web page, insert, into the web page, a JavaScript snippet that corresponds to the dynamic content experience.
